(19) United States
(12) Patent Application Publication
(10) Pub. No.: US 2020/0304446 A1
(43) Pub. Date: Sep. 24, 2020

(54) MESSAGE COMMUNICATION APPARATUS, NON-TRANSITORY COMPUTER READABLE MEDIUM, AND DISPLAY CONTROL METHOD

(71) Applicant: FUJI XEROX CO., LTD., Tokyo (JP)

(72) Inventors: Mamoru SASAMAE, Kanagawa (JP); Kenji NOMURA, Kanagawa (JP); Yujiro KOBAYASHI, Kanagawa (JP); Kiyoshi YASUKAWA, Kanagawa (JP); Masaki KUROKAWA, Kanagawa (JP)

(73) Assignee: FUJI XEROX CO., LTD., Tokyo (JP)

(21) Appl. No.: 16/557,326

(22) Filed: Aug. 30, 2019

(30) Foreign Application Priority Data
Mar. 22, 2019 (JP) 2019-054343

(51) Int. Cl. H04L 12/58

(52) U.S. Cl. CPC H04L 51/18; H04L 51/02; H04L 51/046; H04L 51/26; H04L 51/16

(57) ABSTRACT

A message communication apparatus includes an operating unit, and a controller. The operating unit activates a chat bot. The chat bot runs in a messaging service in which users exchange a message. The chat bot exchanges a message with a user. The controller causes, if the chat bot includes multiple chat bots activated through operation of the operating unit by multiple users, a chat bot activated by a specific user to respond to a message from the specific user.

### CROSS-REFERENCE TO RELATED APPLICATIONS

This application is based on and claims priority under 35 USC 119 from Japanese Patent Application No. 2019-054343 filed Mar. 22, 2019.

### BACKGROUND

### (i) Technical Field

The present disclosure relates to a message communication apparatus, a non-transitory computer readable medium, and a display control method.

### (ii) Related Art

Japanese Unexamined Patent Application Publication No. 2014-164522 describes a message notification apparatus that provides notification of a message that reports the result of an operation performed according to an operational instruction from a user, with explicit indication of the destination of the message. An operational instruction detector detects an operational instruction from a message, and identifies a member who has written the message as an instructor. A report message display shows, on a family message board, a message about the result of an operation performed according to the operational instruction, with the instructor explicitly indicated as the destination of the message.

Messaging services refer to services in which messages are exchanged through a chat, a social networking service (SNS), or other methods among users participating in the chat or the SNS. For such a messaging service, (human-personified) software robot programs (to be referred to as “chat bots” hereinafter) have been proposed that run in the messaging service and are designed to simulate speech- or text-based interactions with humans. A chat bot is programmed to detect a specific word or phrase from a message entered by a user, and output a suitable response prepared in advance. Some chat bots are managed by a messenger service account that has been assigned to a company, a store, or other such entity for advertising or commercial purposes. Through exchange of messages, the user is able to enjoy conversation with a chat bot in a chat room, and also make the chat bot execute various services.

There are cases where, with multiple users enjoying a chat in a chat room, each individual user makes a chat bot active in the chat room (which will be referred to as “inviting” of a chat bot hereinafter). This results in multiple chat bots existing in the same chat room. Accordingly, a situation may arise where, when a given user sends a message to a chat bot, another chat bot not intended by the user responds to this message.

### SUMMARY

Aspects of non-limiting embodiments of the present disclosure relate to a technique that, for a case where a user exchanges messages with a chat bot in a chat room, reduces the risk of an unintended chat bot responding to a message, in comparison to when the user does not specify which chat bot is to respond to a message in the chat room.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a message communication apparatus including an operating unit, and a controller. The operating unit activates a chat bot. The chat bot runs in a messaging service in which users exchange a message. The chat bot exchanges a message with a user. The controller causes, if the chat bot includes multiple chat bots activated through operation of the operating unit by multiple users, a chat bot activated by a specific user to respond to a message from the specific user.

### BRIEF DESCRIPTION OF THE DRAWINGS

Exemplary embodiment of the present disclosure will be described in detail based on the following figures, wherein:

FIG. 1 illustrates a system configuration according to an exemplary embodiment;

FIG. 2 is a functional block diagram according to the exemplary embodiment;

FIG. 3 is a block diagram illustrating a configuration according to the exemplary embodiment;

FIG. 4 illustrates registration of setting information according to the exemplary embodiment;

FIG. 5 illustrates a setting information table according to the exemplary embodiment;

FIG. 6 illustrates switching of printers by the same user;

FIG. 7 illustrates switching of multiple printers by a single chat bot;

FIG. 8 illustrates associations between individual chat bots and the corresponding printers according to the exemplary embodiment;

FIG. 9 illustrates registration of chat bots for each individual user according to the exemplary embodiment;

FIG. 10 illustrates a screen display according to a reference example;

FIG. 11 is a process flowchart according to the exemplary embodiment;

FIG. 12 illustrates a first-condition setting screen according to the exemplary embodiment;

FIG. 13 illustrates a second-condition setting screen according to the exemplary embodiment;

FIG. 14 illustrates a screen display according to the exemplary embodiment (Part 1);

FIG. 15 illustrates usage count of each individual chat bot according to the exemplary embodiment;

FIG. 16 illustrates a screen display according to the exemplary embodiment (Part 2);

FIG. 17 illustrates a screen display according to the exemplary embodiment (Part 3);

FIG. 18 illustrates a screen display according to the exemplary embodiment (Part 4);

FIG. 19 illustrates a screen display according to the exemplary embodiment (Part 5);

FIG. 20 illustrates a screen display according to the exemplary embodiment (Part 6); and

FIG. 21 illustrates a system configuration according to a modification.

### DETAILED DESCRIPTION

An exemplary embodiment of the present disclosure will be described below with reference to the drawings. The following description assumes that a chat bot according to the exemplary embodiment is a chat bot that provides a service with which printing is executed in response to a message from a user (to be referred to as print service hereinafter). The term chat bot as used herein refers to a software program robot that runs in accordance with a messaging service. A chat bot will be sometimes called print bot as a chat bot corresponding to a print service.

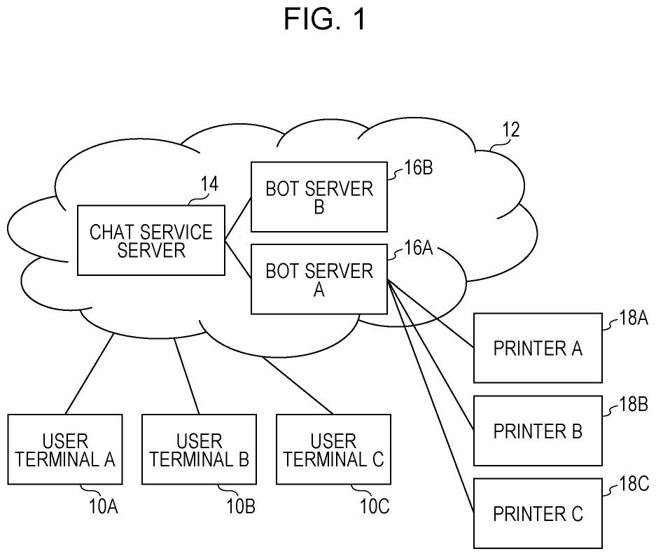

FIG. 1 illustrates the general configuration of a messaging service system according to the exemplary embodiment. The messaging service system includes user terminals A to C (10A to 10C), a chat service server 14, bot servers A and B (16A and 16B), and printers A to C (18A to 18C).

The user terminals A to C (10A to 10C) each represent a terminal used by a user of a messaging service. Examples of such user terminals include smart phones, tablet terminals, and personal computers (PCs). Although FIG. 1 depicts three user terminals, the user terminal A (10A), the user terminal B (10B), and the user terminal C (10C), there may be any number of user terminals. A user operates the user terminal A, B, or C (10A, 10B, or 10C) to access the chat service server 14 in a cloud 12, and exchanges a message with another user or a chat bot. The following description assumes that a user A operates the user terminal A, a user B operates the user terminal B, and a user C operates the user terminal C. The user terminals A to C (10A to 10C) are connected with the chat service server 14 in such a way that allows data to be transmitted and received via a wired or wireless communication network. An example of a communication network is a public line such as the Internet. Alternatively, the communication network may be a private line.

The chat service server 14 is a cloud server in the cloud 12 that provides a chat service. The chat service server 14 includes one or more server computers. The chat service server 14 executes overall processing related to message exchange, such as sending and receiving of messages to and from the user terminals A to C and on-screen displaying of message sending and reception. In addition to handling message exchange between two users, the chat service server 14 provides the ability to create a group of three or more users, and handle exchange of messages within the group (group chat). Further, the chat service server 14 operates in cooperation with the bot server A (16A) and the bot server B (16B) to handle message exchange with respect to chat bots provided by the bot server 16A and the bot server 16B. Examples of user-to-chat bot message exchange include message exchange between a single user and the corresponding chat bot, and message exchange between multiple users and the corresponding chat bots.

The bot server A (16A) and the bot server B (16B) each serve as a message communication apparatus according to the exemplary embodiment. Each of the bot server A (16A) and the bot server B (16B) is installed with a software robot program for implementing a chat bot that handles message exchange with users. Each bot server executes the program. Each of the bot server A (16A) and the bot server B (16B) may be managed by a messenger service account assigned to a company, a store, or other such entity for advertising and commercial purposes.

Each of the bot server A (16A) and the bot server B (16B) operates in cooperation with the chat service server 14 via a specific application programming interface (API). Each bot server handles message exchange with a user, and automatically responds to a message from the user and returns a message. The specific API is an API for using the chat service server 14. Although any API system may be employed, an exemplary API may be an API in Java (registered trademark) script Object Notation (JSON) format, with which JSON data in a specified format is sent to a specific URL of the chat service server 14 in POST or GET format, and the result is returned as data in JSON format.

If a message from a user contains an operational instruction, the bot server A (16A) and the bot server B (16B) each execute a specific kind of service according to the operational instruction. In the exemplary embodiment, the bot server A (16A) serves as a “print bot” that, if a message from a user contains a print instruction, causes the printer A (18A), the printer B (18B), or the printer C (18C) to operate in accordance with the print instruction and execute printing. In this regard, the bot server 16B is capable of providing any given service in accordance with an operational instruction provided from a user. Although FIG. 1 depicts two bot servers, the bot server A (16A) and the bot server B (16B), there may be any number of bot servers. A single bot server may constitute multiple chat bots.

The bot server A serving as a chat bot (or print bot) drives each of the printers A to C in accordance with setting information registered for each user in advance and related to operation of the software robot program, and executes printing. It can be also said that such setting information represents an operational condition for operating each of the printers A to C. For example, the user A enters and registers, through operation on the user terminal A, setting information for operating the printer A, and the user B enters and registers, through operation on the user terminal B, setting information for operating the printer B.

The printer A (18A), the printer B (18B), and the printer C (18C) each execute printing in response to a command from the bot server A. The number of printers is not limited to three but may be four or more.

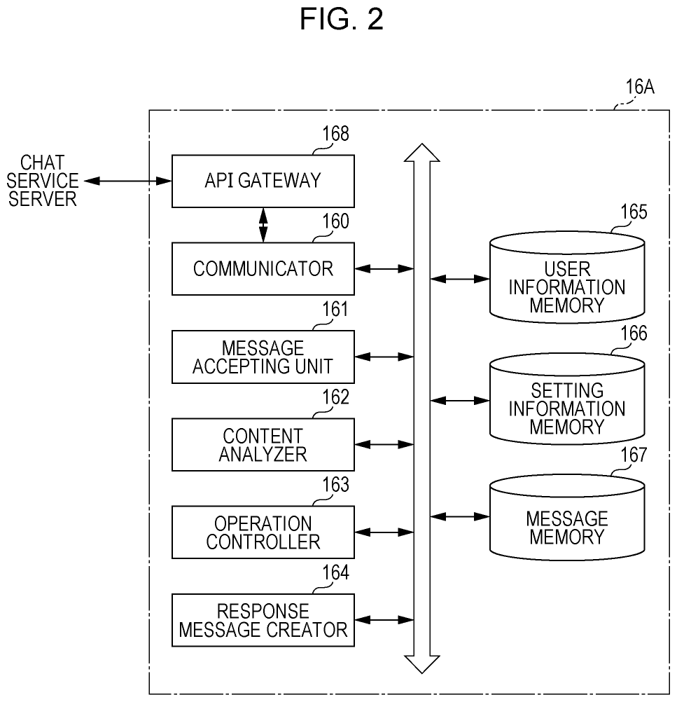

FIG. 2 is a functional block diagram of the bot server A (16A). The bot server A includes, as functional blocks, a communicator 160, a message accepting unit 161, a content analyzer 162, an operation controller 163, a response message creator 164, a user information memory 165, a setting information memory 166, a message memory 167, and an API gateway 168.

The communicator 160 communicates with the chat service server 14 and with each of the printers A, B, and C. The communicator 160 communicates with the chat service server 14 via the API gateway 168 to exchange messages. The communicator 160 outputs, to the message accepting unit 161, a message received from the chat service server 14 via the API gateway 168, that is, a message from each of the user terminals A to C. The communicator 160 also sends a response message created by the response message creator 164 to the chat service server 14 (i.e., each of the user terminals A to C) via the API gateway 168. Further, in accordance with a command from the operation controller 163, the communicator 160 outputs a print command to the printer A, B, or C to drive the printer A, B, or C.

The message accepting unit 161 accepts input of a message from the communicator 160, and outputs the message to the content analyzer 162. The message contains a message related to registration of setting information. The message accepting unit 161 sequentially stores each received message into the message memory 167.

The content analyzer 162 analyzes the contents of an accepted message, and outputs the analysis results to the operation controller 163. Specifically, the content analyzer 162 recognizes a user identifier (user ID) contained in an accepted message, and extracts a text portion included in the message and executes a syntax analysis of the extracted test portion. Any syntax analysis method may be employed. For example, an input message is broken into morphemes, and then nouns, adjectives, verbs, and interrogative pronouns are extracted as keywords. If the text portion of a message contains an operational instruction, the content analyzer 162 analyzes the operational instruction, and outputs the analysis results to the operation controller 163. Examples of operational instructions according to the exemplary embodiment include a print instruction with respect to each of the printers A, B, and C and setting information on each of the printers A, B, and C.

The operation controller 163 functions as a controller. Based on the analysis results obtained by the content analyzer 162, the operation controller 163 registers individual users and the corresponding printers A, B, and C into the setting information memory 166 in association with each other. The operation controller 163 also outputs a print command to the printer A, B, or C via the communicator 160.

The response message creator 164 creates a response message in accordance with the analysis results obtained with the content analyzer 162, and sends the response message to the chat service server 14 via the communicator 160.

The user information memory 165 stores, in the form of a table, information about each user who uses the chat service server 14, in particular, information about a user who uses a chat bot implemented by the bot server A. Each chat bot is assigned a specific account for use in the chat service implemented by the chat service server 14. A user specifies this account and performs a predetermined operation to thereby confirm to use the chat bot. An example of such user information is a user ID. The user information memory 165 may store information on what authority each individual user has.

The setting information memory 166 stores, in the form of a table, setting information for each individual user who uses a chat bot implemented by the bot server A. Setting information may include items such as, but not limited to, identification information of a printer to be used, color mode, paper size, and the number of copies. Setting information may be determined in accordance with the kind of service to be provided by the bot server A. If the service to be provided is a print service, setting information is information related to printing, and if the service to be provided is a search service, setting information is information related to search conditions. As such, setting information defines what kind of service is provided, and may contain multiple items.

A user operates a menu displayed on the user terminal and registers a chat bot and a printer in association with each other. Information on what chat bot is associated with what printer for each user is stored into the setting information memory 166 as a table. Further, a user operates a menu displayed on the user terminal and invites a chat bot previously registered by the user to a chat room, thus making the chat bot active in the chat room. When a chat bot is active, the chat bot is able to accept an instruction based on a request made from a user. Specifically, the user selects “Invite” from the menu displayed on the user terminal, and specifies a desired chat bot to thereby invite the chat bot. Techniques for inviting another user or chat bot to a chat room in a chat service are known in the art. In response to the user inviting a chat bot, the operation controller 163 adds to the chat bot a flag indicating that the chat bot has been invited, and stores the resulting information into the setting information memory 166. By referencing a table stored in the setting information memory 166, the operation controller 163 identifies chat bots registered for individual users, and also identifies which chat bot has been invited to a chat room.

The message memory 167 stores a history of messages accepted from the user by the message accepting unit 161.

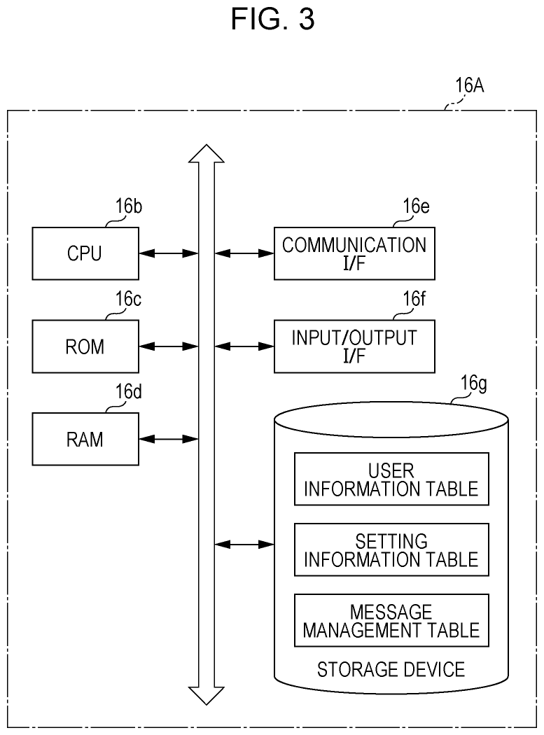

FIG. 3 is a block diagram illustrating the configuration of the bot server A. The bot server A, which is made up of one or more server computers, includes at least one CPU 16b, a ROM 16c, a RAM 16d, a communication interface (I/F) 16e, an input/output I/F 16f, and a storage device 16g.

In implementing the function of a chat bot, the at least one CPU 16b reads out a bot app stored in the ROM 16c or the storage device 16g, and uses the RAM 16d as a working memory. That is, the CPU 16b automatically responds to a message from a user, and if the message contains an operational instruction, the CPU 16b drives the printer A, B, or C in accordance with the operational instruction. The CPU 16b executes the bot app to implement the following components illustrating FIG. 2: the message accepting unit 161, the content analyzer 162, the operation controller 163, the response message creator 164, and the API gateway 168. The CPU 16b functions as an operating unit, a controller, and a registration unit.

The communication I/F 16e handles exchange of messages with the chat service server 14, and outputs a print command to the printer A, B, or C.

The input/output I/F 16f sends and receives data to and from an input device such as a keyboard or a mouse, an image output device such as a display device, or other devices.

The storage device 16g is implemented by a hard disk drive (HDD), a solid state drive (SSD), or other such non-volatile memory. The storage device 16g stores, in addition to a bot app, a user information table, a setting information table, and a message management table. The storage device 16g implements the user information memory 165, the setting information memory 166, and the message memory 167 that are illustrated in FIG. 2.

Although a software robot program for implementing a chat bot is executed by the CPU in the exemplary embodiment, a part of a chat bot may be implemented not by execution of a program but by hardware processing. Such hardware processing may be performed by using circuitry such as an ASIC or a field programmable gate array (FPGA).

The following describes registration of setting information, with respect to the user A and the user B by way of example.

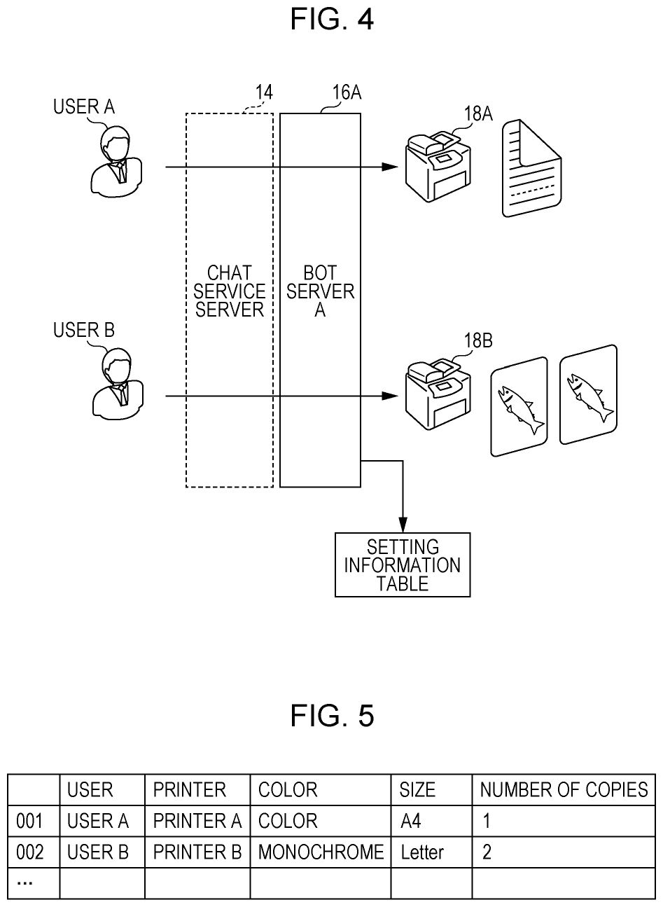

FIG. 4 schematically illustrates a setting registration process performed by the user A and the user B.

The user A and the user B each perform, with respect to a chat bot to which a specific account has been assigned in a chat service, a specific operation indicative of the intention to use the chat bot. Then, the bot server A (16A) assigns a user identifier (user ID) to each of the user A and the user B. The bot server A (16A) also assigns, to each of the printers A to C, a printer identifier (printer ID) for uniquely identifying the printer. As such a user ID, a chat service account of each of the user A and the user B may be used as it is.

Then, the user A sends a message to the bot server A (16A) via the chat service server 14, causing the bot server A (16A) to register setting information while specifying the printer A, the printer B, or the printer C. For example, the user A specifies the printer A, and then sends a message with the following items of information specified as setting information:

### Color Mode: Color

### Paper Size: A4

### Number of Copies: 1

Upon receiving such a message, the bot server A analyzes the contents of the message, and if the message is interpreted to be setting information, the bot server A associates the user A with the printer A and then records the above-mentioned setting information into the setting information table.

The same applies to the user B. The user B sends a message to the bot server A (16A) via the chat service server 14, causing the bot server A (16A) to register setting information while specifying the printer A or the printer B. For example, the user B specifies the printer B, and then sends a message with the following items of information specified as setting information:

### Color Mode: Monochrome

### Paper Size: Letter

### Number of Copies: 2

Upon receiving such a message, the bot server A analyzes the contents of the message, and if the message is interpreted to be setting information, the bot server A associates the user B with the printer B and then records the above-mentioned setting information into the setting information table.

FIG. 5 illustrates an exemplary setting information table stored in the setting information memory 166. For each user, printer, color (color mode), size (paper size), and the number of copies (the number of sets) are recorded in association with each other. More specifically, for each piece of user identification information, printer identification information, color (color mode), size (paper size), and the number of copies (the number of sets) are recorded in association with each other.

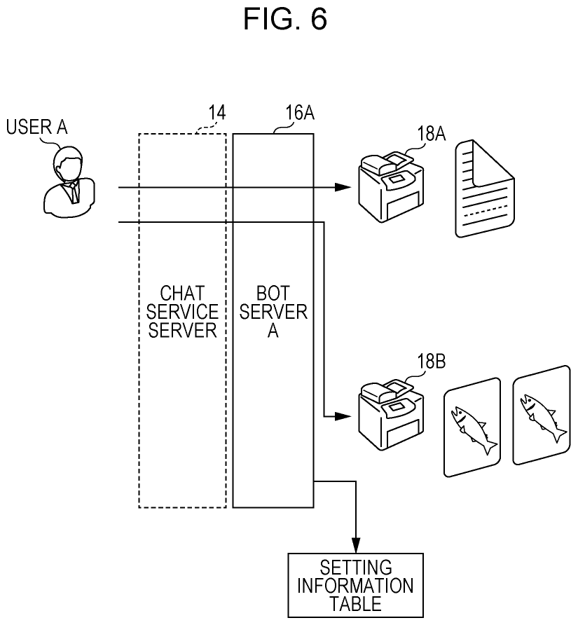

In this regard, there are also often cases where the user A wants to not only register setting information with respect to the printer A but also register a different set of setting information with respect to the printer B. Examples of such cases include when, as illustrated in FIG. 6, after the user A registers setting information with respect to the printer A, the user A registers a different set of setting information with respect to the printer B. For instance, with respect to the printer A, the user A registers the following items of information as setting information on the printer A:

### Color Mode: Color

### Paper Size: A4

### Number of Copies: 1

Then, with respect to the printer B, the user A registers the following items of information as setting information on the printer B:

### Color Mode: Monochrome

### Paper Size: Letter

### Number of Copies: 2

The bot server A associates the user A with the printer A and setting information on the printer A, and also associates the user A with the printer B and setting information on the printer B. The bot server A registers these pieces of associated information into the setting information table. Then, in response to an instruction from the user A, the bot server A switches between the printer A and the printer B to select one of the printers, and drives the selected printer.

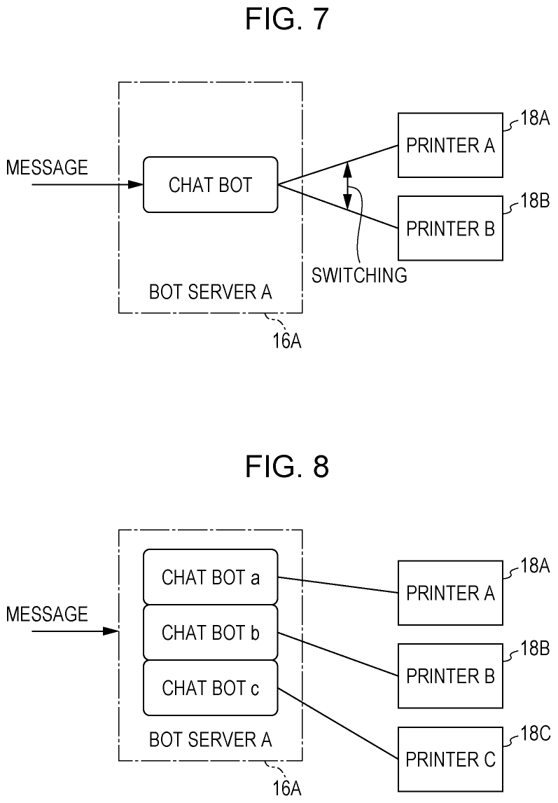

FIG. 7 schematically illustrates a process performed by a chat bot implemented by the bot server A. The chat bot operates in conjunction with two printers, the printer A and the printer B, in providing a print service to the user A. The chat bot associates the user A with the printer A and the printer B. Upon receiving a message from the user A, the chat bot analyzes the contents of the message. If the contents of the message correspond to the printer A, the chat bot switches to the printer A and executes a print service. If the contents of the message correspond to the printer B, the chat bot switches to the printer B and executes a print service.

At this time, the user A has to perform the operation of switching between the printer A and the printer B in accordance with the kind of the print service to be provided. For example, when wishing to print at the printer A, the user A has to send the following message to the chat bot:

“Print @ printer A”.

When wishing to print at the printer B, the user A has to send the following message to the chat bot:

“Print @ printer B”.

This means that the user A has to send an appropriate message while paying particular attention to what printer is associated with what kind of setting information. This results in a rather cumbersome process. In particular, if a print service is to be provided by the chat bot operating in conjunction with, in addition to the printers A and B, the printer C and even more different printers, such switching action takes place many times commensurate with the number of printers to be switched.

Although it would be conceivable to set one of such multiple printers as a default printer and, in response to a print instruction, use this default printer, the same switching action as described above is still necessary if a printer different from the default printer is to be used.

Accordingly, in the exemplary embodiment, the need for the user to perform cumbersome switching of printers is mitigated by employing a configuration in which multiple chat bots are implemented by the bot server A, with each chat bot operating in conjunction with one or more printers.

FIG. 8 schematically illustrates a process performed by multiple chat bots implemented by the bot server A according to the exemplary embodiment.

Three chat bots a to c are implemented by the bot server A. The chat bots a to c are all identical in function. The chat bots a to c are all implemented by identical software robot programs. These software robot programs may be individually installed, or may be implemented as different program modules constituting the same single program.

The chat bot a operates in conjunction with, for example, the printer A. In accordance with a message from a user, the chat bot a drives the printer A and provides a print service.

The chat bot b operates in conjunction with, for example, the printer B. In accordance with a message from a user, the chat bot b drives the printer B and provides a print service.

The chat bot c operates in conjunction with, for example, the printer C. In accordance with a message from a user, the chat bot c drives the printer C and provides a print service.

If a user wants to print at the printer A, the user sends, to the chat bot a, a message such as “Print” instructing that printing be performed. If a user wants to print at the printer B, the user sends, to the chat bot b, a message such as “Print” instructing that printing be performed. If a user wants to print at the printer C, the user sends, to the chat bot c, a message such as “Print” instructing that printing be performed. In this way, printing may be performed at a desired printer by the user simply sending the above-mentioned message to the printer.

The conjunction relationships between individual chat bots a to c and the corresponding printers A to C may not be fixed but may be set dynamically for each individual user. An example of such a case is when, for the user B, the chat bot a operates in conjunction with the printer B and the chat bot c operates in conjunction with the printer C, and for the user C, the chat bot a operates in conjunction with the printer A.

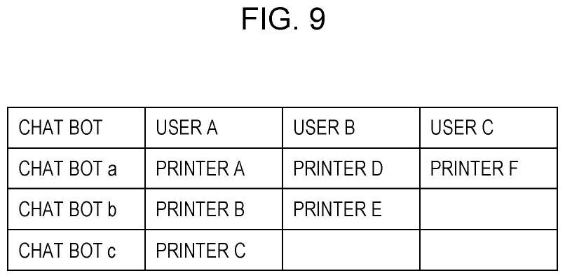

FIG. 9 illustrates, for each individual user, an exemplary conjunction relationship between each individual chat bot and the corresponding printer according to the exemplary embodiment. With respect to the user A, the chat bot a and the printer A operate in conjunction with each other, the chat bot b and the printer B operate in conjunction with each other, and the chat bot c and the printer C operate in conjunction with each other. With respect to the user B, the chat bot a and a printer D operate in conjunction with each other, and the chat bot b and a printer E operate in conjunction with each other. With respect to the user C, the chat bot a and a printer F operate in conjunction with each other. The chat bots a to c each register, into the setting information table, information about what chat bot is associated with what printer. From a user ID contained in a message received from a user, the chat bots a to c each identify the corresponding printer by referencing the setting information table, and drives the identified printer.

Although FIGS. 8 and 9 depict a case where a single chat bot operates in conjunction with a single printer, this is not to be construed in a limiting sense. Alternatively, a single chat bot may operate in conjunction with multiple printers.

In exchanging messages with another user in a chat room, the user A, the user B, or the user C invites a pre-registered chat bot into the chat room, thus setting the chat bot active. For example, in exchanging messages with the user B, the user A invites the chat bot a from among pre-registered chat bots a to c, thus activating the chat bot a. Likewise, the user B invites the chat bot b, which is a pre-registered chat bot, thus activating the chat bot b. If, in the same chat room, multiple users each invite a desired chat bot from among pre-registered chat bots, this results in multiple chat bots being set active in the same chat room.

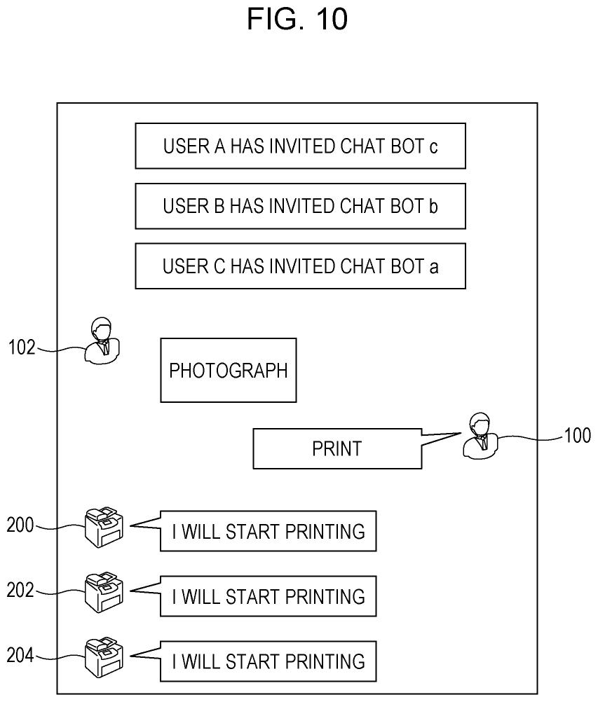

FIG. 10 illustrates an exemplary reference screen displayed on the user terminal A operated by the user A. The reference screen corresponds to a case where the user A, the user B, and the user C participate in the same chat room and exchange messages. In this case, the user A has invited the chat bot c into the chat room and thus activated the chat bot c, the user B has invited the chat bot b into the chat room and thus activated the chat bot b, and the user C has invited the chat bot a into the chat room and thus activated the chat bot a.

On the screen, the following messages are displayed sequentially in the order stated below, indicating that each user has invited a chat bot:

“User A has invited chat bot c”.
“User B has invited chat bot b”.
“User C has invited chat bot a”.

Then, the user B represented by a representational graphic (to be referred as “icon” hereinafter) 102 sends a photograph. Upon seeing the photograph, the user A represented by an icon 100 sends a message “Print” to instruct that the photograph be printed. In this case, even though the user A intends the instruction to be directed to the chat bot c, the chat bots a to c, which are active in the chat room, respond to the instruction. This results in a situation where the chat bot a represented by an icon 200 responds with “I will start printing” and executes printing, the chat bot b represented by an icon 202 responds with “I will start printing” and executes printing, and the chat bot c represented by an icon 204 responds with “I will start printing” and executes printing.

Of course, conceivably, this may be avoided if, when instructing that printing be performed, the user A first selects the chat bot c so that only the chat bot c will respond, and then instructs that printing be performed. However, this makes it necessary for the user A to perform a cumbersome operation.

Accordingly, in order to avoid a response from a chat bot not intended by the user, the exemplary embodiment employs a control such that each chat bot responds to a user's message in accordance with a predetermined rule.

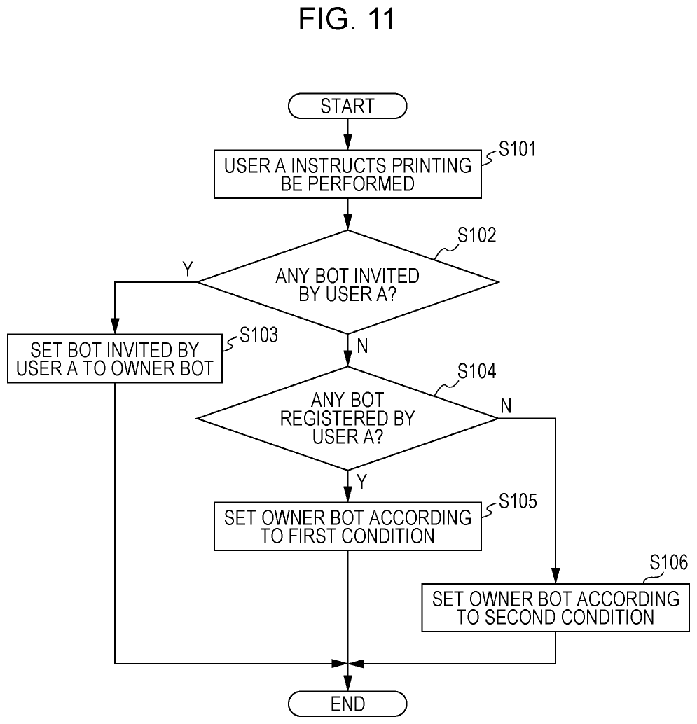

FIG. 11 is a flowchart of a process performed in the operation controller 163 of the bot server A (16A).

First, the user A sends a message instructing that printing be performed (S101). Then, the operation controller 163 determines whether the user A has invited a chat bot to the current chat room and thus activated the chat bot (S102). Information as to whether a user has invited and thus activated a chat bot is stored in the setting information table of the setting information memory 166. The operation controller 163 references the information stored in the setting information memory 166 in performing the above-mentioned determination.

If the user A has invited a chat bot (YES at S102), the chat bot invited by the user A is set as an “owner bot”, which is a chat bot to respond to a message from the user A (S103). For example, if the user A has invited the chat bot c as illustrated in FIG. 10, the chat bot c is set as an owner bot, so that only the chat bot c will respond to a message “Print” provided from the user A and other chat bots will not respond to the message.

If the user A has not invited a chat bot (NO at S102), the operation controller 163 then determines whether there is any chat bot registered by the user A (S104). Information on user-registered chat bots is stored in the setting information table of the setting information memory 166. The operation controller 163 references the information stored in the setting information memory 166 in performing the above-mentioned determination. If there is any chat bot registered by the user A, an owner bot is set in accordance with a predetermined first condition (S105). If there is no chat bot registered by the user A, an owner bot is set in accordance with a predetermined second condition (S106). The owner bot thus set responds to a message from the user A. The first condition and the second condition are stored in the setting information memory 166. Each of the first and second conditions may be previously set and stored as a default condition on the system side, or may be selected as appropriate by the user from multiple conditions and stored into the setting information memory 166.

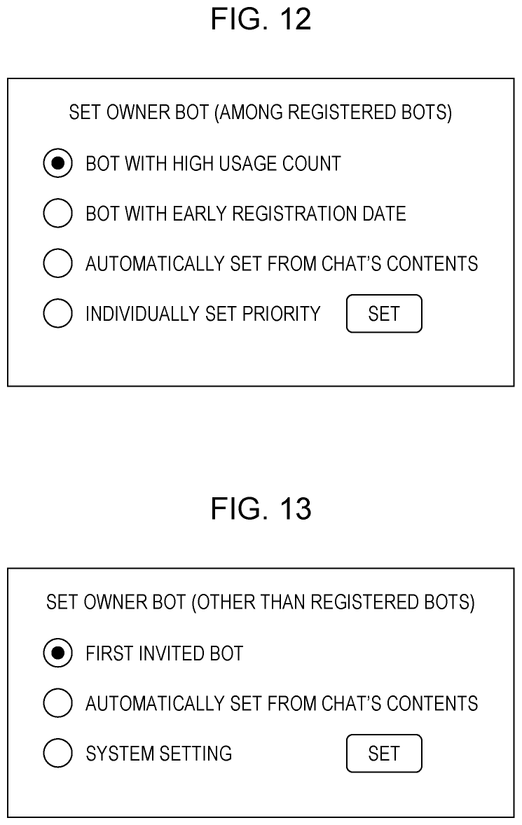

FIG. 12 illustrates an exemplary setting screen used when a user sets a first condition from among multiple conditions. For example, when a user initiates a chat in a chat room, the operation controller 163 displays this screen on the user terminal, and a first condition is set by prompting the user to make a selection.

The first condition is a condition used if no chat bot has been invited by the user A and if there is a chat bot registered by the user A. For example, the first condition is selected from the following:

(1) Chat bot with high usage count
(2) Chat bot with early registration date
(3) Set automatically from the chat's contents
(4) Individually set priority

According to the condition (1), a chat bot with high usage count is set as an owner bot. That is, among multiple chat bots, the chat bot with the highest usage count is set as an owner bot. If there is only one registered chat bot, the chat bot is set as an owner bot. This corresponds to setting of an owner bot based on the history of chat bot usage. The history of chat bot usage refers to a history related to instructions given to a chat bot in a chat room.

According to the condition (2), the earliest-registered chat bot is set as an owner bot. If the registration dates of multiple chat bots are the same, one of the chat bots (e.g., the above-mentioned used chat bot) is set as an owner bot. This corresponds to setting of an owner bot based on chat bot registration, more specifically, the state of chat bot registration (including the timing of registration).

According to the condition (3), the contents of a chat in a chat room are analyzed, and a chat bot best suited for the contents of the chat is set as an owner bot. One example of such a case is when, with each chat bot associated with a different printer, a chat bot associated with a printer capable of printing at a quality suited for the chat's contents is set as an owner bot. For example, if an instruction to print a photograph in full color is given from a user, a chat bot associated with a printer suited for photograph printing is set as an owner bot. This corresponds to setting of an owner bot based on the contents of a chat. The contents of a user's chat in a chat room represent the user's usage history.

According to the condition (4), a user manually sets priorities for individual chat bots. For example, the user sets the priorities as follows:

First priority: chat bot c
Second priority: chat bot b
Third priority: chat bot a

The chat bot with the first priority is set as an owner bot.

FIG. 13 illustrates an exemplary setting screen used when a user sets a second condition from among multiple conditions. For example, when a user initiates a chat in a chat room, the operation controller 163 displays this screen on the user terminal, and a second condition is set by prompting the user to make a selection.

The second condition is a condition used if no chat bot has been invited by the user A, and if no chat bot has been previously registered by the user A. For example, the second condition is selected from the following:

(1) First invited chat bot
(2) Set automatically from the chat's contents
(3) System setting

According to the condition (1), the chat bot first invited to a chat room is set as an owner bot. For example, if the user C different from the user A invites a chat bot to a chat room for the first time, the first invited chat bot will respond to a user's message.

According to the condition (2), the contents of a chat in a chat room are analyzed, and a chat bot best suited for the contents of the chat is set as an owner bot.

The condition (3) is a default condition set on the system side. For example, a chat bot that has responded to a message from a given user just immediately before is set as an owner bot.

In any one of the cases (1) to (3) above, a chat bot not previously registered by the user A is set as an owner bot. Thus, in order for the user A to have printing actually executed by the chat bot, the user A has to register the chat bot. Accordingly, it is desired for the chat bot set as an owner bot to send, to the user A, a message prompting the user A to register the chat bot. The user A sees this message, registers the chat bot, and further invites and thus activates the chat bot. The user A is thus able to have his or her print instruction executed by the chat bot. In this case, the operation controller 163 may directly regard the operation of registering the chat bot as an operation of inviting the chat bot to the chat room, thus reducing user's operational load.

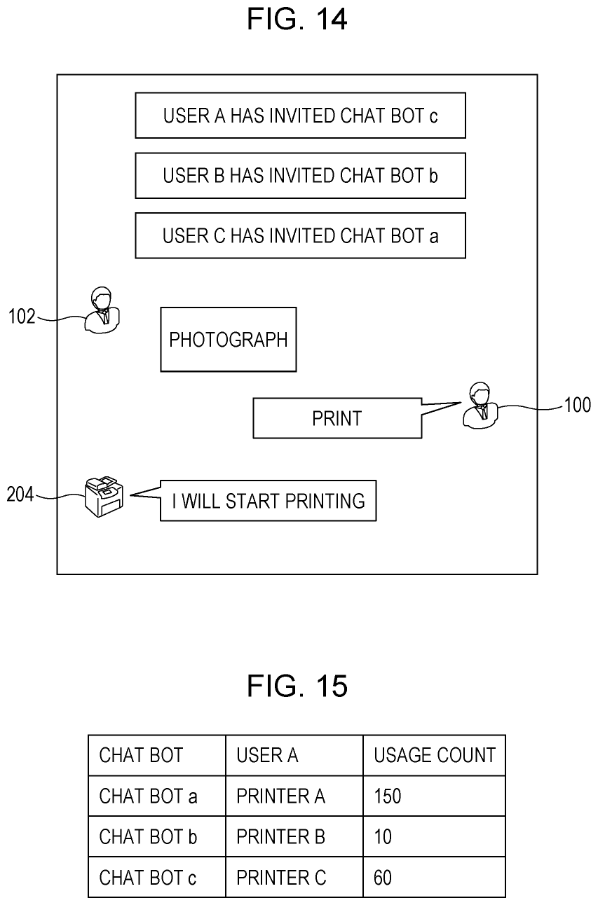

FIG. 14 illustrates an exemplary reference screen displayed on the user terminal A operated by the user A according to the exemplary embodiment. The reference screen corresponds to a case where the user A, the user B, and the user C participate in the same chat room and exchange messages. In this case, the user A has invited the chat bot c into the chat room and thus activated the chat bot c, the user B has invited the chat bot b into the chat room and thus activated the chat bot b, and the user C has invited the chat bot a into the chat room and thus activated the chat bot a.

On the screen, as in FIG. 10, the following messages are displayed sequentially in the order stated below, indicating that each user has invited a chat bot:

“User A has invited chat bot c”.
“User B has invited chat bot b”.
“User C has invited chat bot a”.

The user B represented by the icon 102 sends a photograph. Upon seeing the photograph, the user A represented by the icon 100 sends a message “Print” to instruct that the photograph be printed. Then, in accordance with the process flowchart illustrated in FIG. 11, the operation controller 163 determines at S102 whether the user A has invited a chat bot. In the present case, the user A has invited the chat bot c and thus the process proceeds to S103, where the chat bot c is set as an owner bot so that the chat bot c will respond to a message. Accordingly, the chat bot c represented by the icon 204 responds as follows and executes printing:

“I will start printing”.

At this time, the chat bots a and b are not set as owner bots and thus do not respond to a message from the user A.

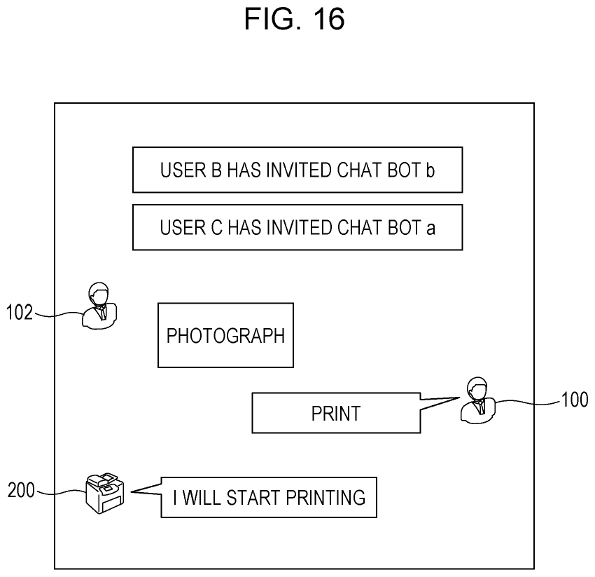

FIGS. 15 and 16 each illustrate a process for a case where “Chat bot with highest usage count” is set as a first condition.

FIG. 15 illustrates an example of usage count representing how many times each individual chat bot registered by the user A has been used. It is assumed that the chat bot a has been used 150 times, the chat bot b has been used 10 times, and the chat bot c has been used 60 times. Information on usage count for each individual chat bot may be stored in the setting information memory 166.

FIG. 16 illustrates an exemplary screen in this case.

On the screen, the following messages are displayed sequentially in the order stated below, indicating that each user has invited a chat bot:

“User B has invited chat bot b”.
“User C has invited chat bot a”.

It is to be noted that in this case, no chat bot has been invited and activated by the user A.

The user B represented by the icon 102 sends a photograph. Upon seeing the photograph, the user A represented by the icon 100 sends a message “Print” to instruct that the photograph be printed. Then, in accordance with the process flowchart illustrated in FIG. 11, the operation controller 163 determines at S102 whether the user A has invited a chat bot. In the present case, the user A has not invited a chat bot and thus the process proceeds to S104, where it is determined whether there is any chat bot registered by the user A. If there is any chat bot registered by the user A, the process proceeds to S105, where an owner bot is set in accordance with a first condition. If the first condition is “Chat bot with highest usage count”, the operation controller 163 references information on usage count stored in the setting information memory 166. The usage counts of individual chat bots are as illustrated in FIG. 15. Since the chat bot a with a usage count of 150 has been used the greatest number of times, the operation controller 163 sets the chat bot a as an owner bot, and controls the chat bot a such that the chat bot a will respond to a message. Accordingly, the chat bot a represented by the icon 200 responds as follows and executes printing:

“I will start printing”.

At this time, the chat bots b and c are not set as owner bots and thus do not respond to a message from the user A.

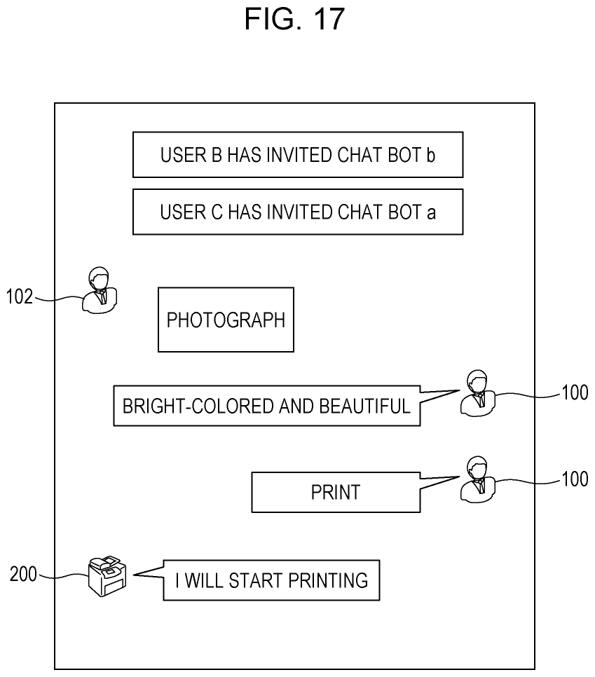

FIG. 17 illustrates a process for a case where “Set automatically from the chat's contents” is set as a first condition.

On the screen, the following messages are displayed sequentially in the order stated below, indicating that each user has invited a chat bot:

“User B has invited chat bot b”.
“User C has invited chat bot a”.

It is to be noted that in this case, no chat bot has been invited and activated by the user A.

The user B represented by the icon 102 sends a photograph. Upon seeing the photograph, the user A represented by the icon 100 sends a message “Print” to instruct that the photograph be printed. Then, in accordance with the process flowchart illustrated in FIG. 11, the operation controller 163 determines at S102 whether the user A has invited a chat bot. In the present case, the user A has not invited a chat bot and thus the process proceeds to S104, where it is determined whether there is any chat bot registered by the user A. If there is any chat bot registered by the user A, the process proceeds to S105, where an owner bot is set in accordance with a first condition. If the first condition is “Set automatically from the chat's contents”, the operation controller 163 selects the most suitable chat bot in accordance with the analysis results obtained by the content analyzer 162. For example, a case is considered where the user A has sent a message “Bright-colored and beautiful” and a message “Print”, the message preceding the message “Print” is analyzed. Then, from the keywords “color” and “bright”, it is interpreted that the user A intends to print in color, and thus a chat bot associated with a printer capable of color printing is selected. If the chat bot a is associated with a color printer, the operation controller 163 sets the chat bot a as an owner bot, and controls the chat bot a such that the chat bot a will respond to a message. Accordingly, the chat bot a represented by the icon 200 responds as follows and executes printing:

“I will start printing”.

At this time, the chat bots b and c are not set as owner bots and thus do not respond to a message from the user A.

In FIGS. 14 to 17, an owner bot is set in accordance with a first condition, and the owner bot is controlled to respond to a message from the user A and execute printing. Alternatively, an owner bot may be given only an authority to respond to a message and not an output authority, and the actual output process using a printer may be processed by an invited chat bot.

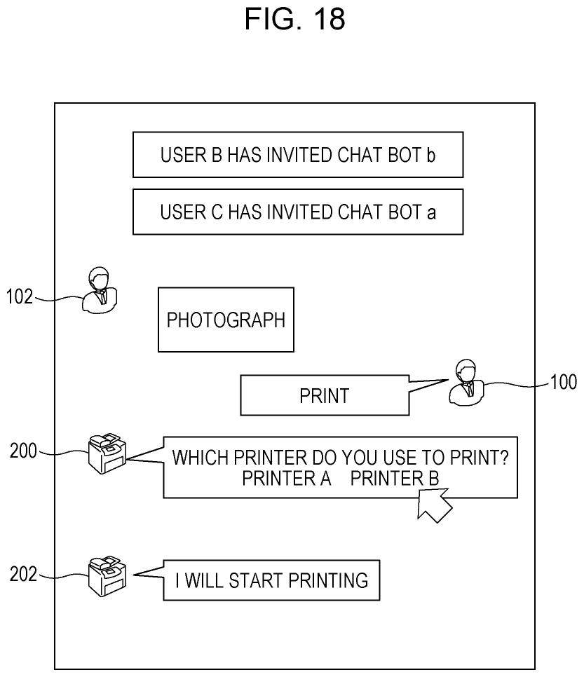

FIG. 18 illustrates an exemplary screen in this case. This corresponds to a case where “Chat bot with highest usage count” is set as a first condition.

On the screen, the following messages are displayed sequentially in the order stated below, indicating that each user has invited a chat bot:

“User B has invited chat bot b”.
“User C has invited chat bot a”.

The user B represented by the icon 102 sends a photograph. Upon seeing the photograph, the user A represented by the icon 100 sends a message “Print” to instruct that the photograph be printed. Then, in accordance with the process flowchart illustrated in FIG. 11, the operation controller 163 determines at S102 whether the user A has invited a chat bot. In the present case, the user A has not invited a chat bot and thus the process proceeds to S104, where it is determined whether there is any chat bot registered by the user A. If there is any chat bot registered by the user A, the process proceeds to S105, where an owner bot is set in accordance with a first condition. If the first condition is “Chat bot with highest usage count”, the operation controller 163 references information on usage count stored in the setting information memory 166. The usage counts of individual chat bots are as illustrated in FIG. 15. Since the chat bot a with a usage count of 150 has been used the greatest number of times, the operation controller 163 sets the chat bot a as an owner bot, and controls the chat bot a such that the chat bot a will respond to the user's message. Then, the chat bot a represented by the icon 200 sends a response message “Which printer do you use to print?”, and also lists the printers A and B associated with the chat bots a and b that have already been invited to the current chat room.

If the user selects, for example, the printer B in response to this message, the operation controller 163 controls the chat bot b such that the chat bot b executes the print instruction given from the user A, and the chat bot b represented by the icon 202 sends the following message and executes printing:

“I will start printing”.

It is to be noted that in the above-mentioned case, it is the chat bot a that responds to the message “Print” from the user A, whereas it is the chat bot b that executes printing in accordance with the message “Print” from the user A.

In FIG. 18, the owner bot a lists chat bots that have been invited to the chat room and prompts the user A to select a chat bot. Alternatively, the owner bot a may list chat bots that have been registered by the user A and prompt the user A to select a chat bot.

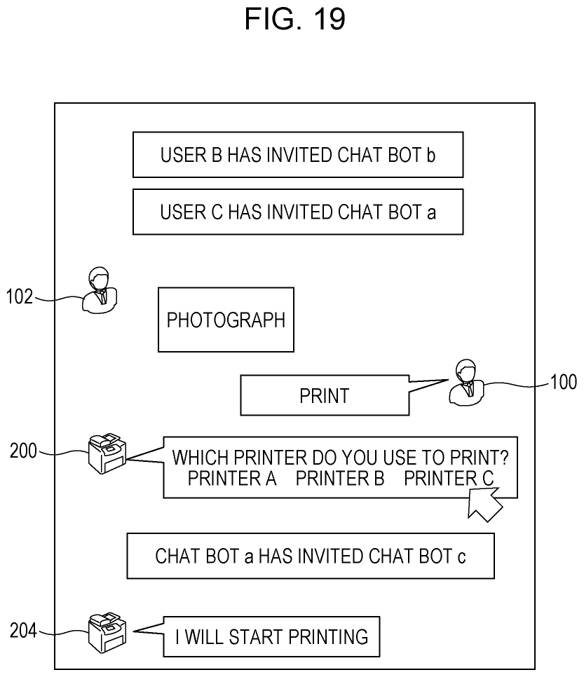

FIG. 19 illustrates an exemplary screen in this case. This corresponds to a case where “Chat bot with highest usage count” is set as a first condition.

On the screen, the following messages are displayed sequentially in the order stated below, indicating that each user has invited a chat bot:

“User B has invited chat bot b”.
“User C has invited chat bot a”.

The user B represented by the icon 102 sends a photograph. Upon seeing the photograph, the user A represented by the icon 100 sends a message “Print” to instruct that the photograph be printed. Then, in accordance with the process flowchart illustrated in FIG. 11, the operation controller 163 determines at S102 whether the user A has invited a chat bot. In the present case, the user A has not invited a chat bot and thus the process proceeds to S104, where it is determined whether there is any chat bot registered by the user A. If there is any chat bot registered by the user A, the process proceeds to S105, where an owner bot is set in accordance with a first condition. If the first condition is “Chat bot with highest usage count”, the operation controller 163 references information on usage count stored in the setting information memory 166. The usage counts of individual chat bots are as illustrated in FIG. 15. Since the chat bot a with a usage count of 150 has been used the greatest number of times, the operation controller 163 sets the chat bot a as an owner bot, and controls the chat bot a such that the chat bot a will respond to the user's message. Then, the chat bot a represented by the icon 200 sends a response message “Which printer do you use to print?”, and also lists the printers A, B, and C associated with the chat bots a, b, and c that have been registered by the user A.

If the user selects, for example, the printer C in response to this message, the operation controller 163 controls the chat bot c such that the chat bot c executes the print instruction given from the user A. At this time, the chat bot c has not been invented to the chat room yet. Accordingly, the operation controller 163 controls the chat bot a such that the chat bot a is forced to invite the chat bot c. Then, the following message is sent:

“Chat bot a has invited chat bot c”.

Subsequently, the chat bot c represented by the icon 204 sends the following message and executes printing:

“I will start printing”.

It is to be noted that in the above-mentioned case, it is the chat bot a that responds to the message “Print” from the user A, whereas it is the chat bot c invited by the chat bot a that executes printing in accordance with the message “Print” from the user A.

In the foregoing description made with reference to FIGS. 18 and 19, an owner bot has an authority to respond but does not have an authority to output. In this case, the owner bot displays a message “Which printer do you use to print?”, and also lists printers to prompt the user A to select a printer. The user A thus has to perform a selecting operation.

In this regard, if an owner bot has an authority to respond but does not have an authority to output, the owner bot may output a predetermined error message. For example, in the case of FIG. 19, the chat bot a set as an owner bot may, in response to the message “Print” from the user A, send the following error message:

“Printing not possible. Please invite a registered chat bot”.

Alternatively, the chat bot a may send the following error message to automatically invite the chat bot c:

“Printing not possible. I will invite chat bot c”.

This may obviate the need for the user A to perform an operation of selecting a printer.

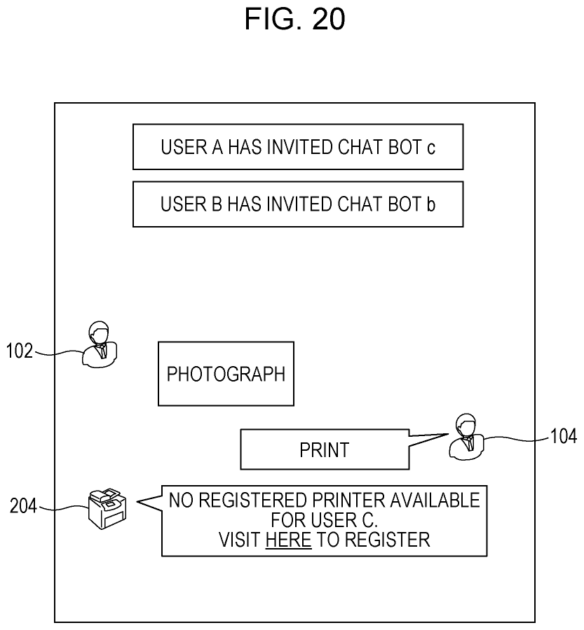

FIG. 20 illustrates a process for a case where “First invited chat bot” is set as a second condition. In the present case, the user A has invited the chat bot c, and the user B has invited the chat bot b. It is assumed that the user C has neither invited nor registered a chat bot.

On the screen, the following messages are displayed sequentially in the order stated below, indicating that each user has invited a chat bot:

“User A has invited chat bot c”.
“User B has invited chat bot b”.

The user B represented by the icon 102 sends a photograph. Upon seeing the photograph, the user C represented by an icon 104 sends a message “Print” to instruct that the photograph be printed. Then, in accordance with the process flowchart illustrated in FIG. 11, the operation controller 163 determines at S102 whether the user C has invited a chat bot. In the present case, the user C has not invited a chat bot and thus the process proceeds to S104, where it is determined whether there is any chat bot registered by the user C. If there is no chat bot registered by the user C, the process proceeds to S106, where an owner bot is set in accordance with a second condition. If the second condition is “First invited chat bot”, the operation controller 163 selects the chat bot c, which is the first chat bot invited to a chat room. Then, the chat bot c represented by the icon 204 acts as an owner bot and sends the following message to prompt the user C to register a chat bot:

“No registered printer available for user C. Visit here to register”.

The user C registers a chat bot in response to the above message, and further invites the chat bot to the chat room. As already described above, at this time, the operation controller 163 may directly regard the operation of registering a chat bot as an operation of inviting the chat bot to the chat room. Subsequently, the chat bot that has been invited and thus activated responds to the message from the user C, and sends the following message and executes printing:

“I will start printing”.

Although an exemplary embodiment of the present disclosure has been described above, the present disclosure is not limited to the described exemplary embodiment but may be practiced with various modifications. Such modifications will be described below.

### Modification 1

The foregoing description of the exemplary embodiment assumes that the chat bot used is a chat bot that provides a print service in response to a message from a user. However, the chat bot may be capable of providing any services other than the print service. Examples of such services include:
Search service for content such as music, news articles, accommodations, books, or food recipes
Ticket booking service
Service for selling items on online flea market site/search/transactional communication
Translation service into other languages

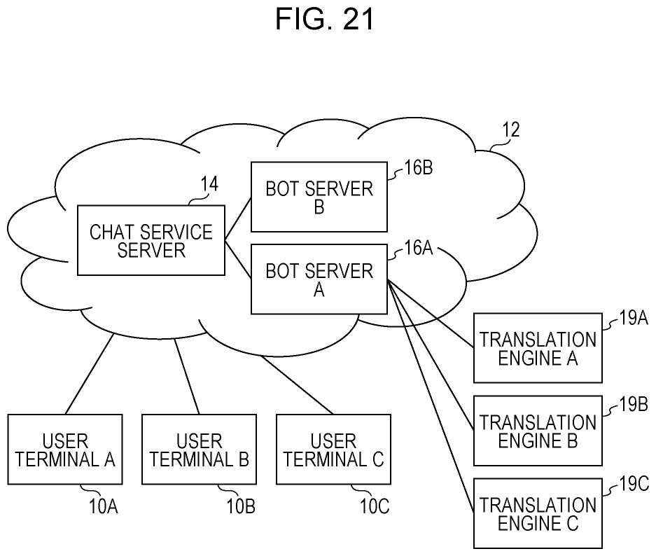

FIG. 21 illustrates a system configuration for a case where a translation service is executed. Unlike in FIG. 1, the system includes, as external apparatuses or devices, a translation engine A (19A), a translation engine B (19B), and a translation engine C (19C), instead of the printer A (18A), the printer B (18B), and the printer C (18C). The translation engine A represents a program (and a translation apparatus or device installed with the program) for translating Japanese into English, the translation engine B represents a program (and a translation apparatus or device installed with the program) for translating Japanese into Chinese, and the translation engine C represents a program (and a translation apparatus or device installed with the program) for translating Japanese into Spanish.

The user A selects the translation engine A, and sets and registers, as setting information, a format such that the original Japanese is displayed following the English translation. As a result, if the user A sends a message “Kyo-wa-aite-imasuka?” (“Are you free?” in Japanese) to a chat bot, the chat bot drives the translation engine A and automatically responds as follows:

“Are you free today?”.
“Kyo-wa-aite-imasuka?”.

For a case where there is an upper limit (e.g., two) on the number of translation engines with which a single chat bot may operate in conjunction, if a chat bot is already operating in conjunction with the translation engines A and B, and if a user desires translation with the translation engine C in this state, a new chat bot is added, and the added chat bot is associated with the translation engine C.

If multiple chat bots exist in the same chat room, one of the chat bots may be set as an owner bot in accordance with the process flowchart illustrated in FIG. 11 and the conditions illustrated in each of FIGS. 12 and 13, and the owner bot may be controlled such that the owner bot will respond to a message from a user.

In the case of a search service, search engines may be used instead of translation engines as external apparatuses or devices. Setting information in this case refers to search conditions. For example, in the case of a search for accommodations, such search conditions may include the number of days, price, hotel grade, and the number of persons. If an upper limit number of times for search condition switching is reached, a new chat bot is added, and the added chat bot and a search engine for a specific search condition are associated with each other. Combinations of printers and printing conditions may be substituted by combinations of search engines and search conditions.

### Modification 2

In the foregoing description of the exemplary embodiment, (1) Chat bot with high usage count has been described above as one example of first condition. Alternatively, in order to level out usage, a chat bot with low usage count may be set as an owner bot.

In addition to or separately from the history of chat bot usage, an owner bot may be set based on user's usage history. Specifically, for example, the tendencies or preferences of a user are analyzed based on the user's usage history, and a chat bot assumed to be highly desirable for the user in accordance with the contents of a chat is automatically set as an owner bot. Further, for a case where a given chat bot has been set as an owner bot in the past but the owner bot has been later manually reset to another chat bot by a user, this correction history may be reflected in setting an owner bot next time.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A message communication apparatus comprising:
an operating unit that activates a chat bot, the chat bot running in a messaging service in which users exchange a message, the chat bot exchanging a message with a user; and
a controller that, if the chat bot comprises a plurality of chat bots activated through operation of the operating unit by a plurality of users, causes a chat bot activated by a specific user to respond to a message from the specific user.

2. The message communication apparatus according to claim 1,
wherein if the chat bot activated by the specific user does not exist, the controller selects, from among the plurality of chat bots, a chat bot that satisfies a first condition, and causes the selected chat bot to respond.

3. The message communication apparatus according to claim 2, further comprising
a registration unit that performs registration of a chat bot for each user,
wherein the controller selects, from among the plurality of chat bots, a chat bot registered by the specific user by using the registration unit, and causes the selected chat bot to respond.

4. The message communication apparatus according to claim 3,
wherein the chat bot selected by the controller is selected in accordance with a usage history of the user.

5. The message communication apparatus according to claim 3,
wherein the chat bot selected by the controller is selected in accordance with a history of chat bot usage by the user.

6. The message communication apparatus according to claim 3,
wherein the chat bot selected by the controller is selected in accordance with the registration.

7. The message communication apparatus according to claim 3,
wherein the chat bot selected by the controller is selected in accordance with a priority.

8. The message communication apparatus according to claim 3,
wherein if no chat bot registered by the specific user exists in the chat room, the controller selects a chat bot that satisfies a predetermined second condition and causes the selected chat bot to respond.

9. The message communication apparatus according to claim 8,
wherein the controller selects, from among the plurality of chat bots, a chat bot that has been activated, and causes the selected chat bot to respond.

10. The message communication apparatus according to claim 2,
wherein if the selected chat bot has an authority to respond to a message but does not have an output authority, the controller causes the selected chat bot to provide an error message in response to the message.

11. The message communication apparatus according to claim 3,
wherein if the selected chat bot has an authority to respond to a message but does not have an output authority, the controller causes the selected chat bot to provide an error message in response to the message.

12. The message communication apparatus according to claim 4,
wherein if the selected chat bot has an authority to respond to a message but does not have an output authority, the controller causes the selected chat bot to provide an error message in response to the message.

13. The message communication apparatus according to claim 5,
wherein if the selected chat bot has an authority to respond to a message but does not have an output authority, the controller causes the selected chat bot to provide an error message in response to the message.

14. The message communication apparatus according to claim 6,
wherein if the selected chat bot has an authority to respond to a message but does not have an output authority, the controller causes the selected chat bot to provide an error message in response to the message.

15. The message communication apparatus according to claim 7,
wherein if the selected chat bot has an authority to respond to a message but does not have an output authority, the controller causes the selected chat bot to provide an error message in response to the message.

16. The message communication apparatus according to claim 8,
wherein if the selected chat bot has an authority to respond to a message but does not have an output authority, the controller causes the selected chat bot to provide an error message in response to the message.

17. The message communication apparatus according to claim 9,
wherein if the selected chat bot has an authority to respond to a message but does not have an output authority, the controller causes the selected chat bot to provide an error message in response to the message.

18. A non-transitory computer readable medium storing a program causing a computer to execute a process, the process comprising:
activating a chat bot, the chat bot running in a messaging service in which users exchange a message, the chat bot exchanging a message with a user; and
if the chat bot comprises a plurality of chat bots activated through operation by a plurality of users, causing a chat bot activated by a specific user to respond to a message from the specific user.

19. A display control method comprising:
activating a chat bot, the chat bot running in a messaging service in which users exchange a message, the chat bot exchanging a message with a user; and
if the chat bot comprises a plurality of chat bots activated through operation by a plurality of users, causing a chat bot activated by a specific user to respond to a message from the specific user, and causing a result to be displayed on a screen.

20. A message communication apparatus comprising:
operating means for activating a chat bot, the chat bot running in a messaging service in which users exchange a message, the chat bot exchanging a message with a user; and
control means for, if the chat bot comprises a plurality of chat bots activated through operation of the operating means by a plurality of users, causing a chat bot activated by a specific user to respond to a message from the specific user.
